(19) United States
(12) Patent Application Publication
(10) Pub. No.: US 2004/0178714 A1
(43) Pub. Date: Sep. 16, 2004

(54) Decorative bulb of a series connected light string

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/384,583

(22) Filed: Mar. 11, 2003

(51) Int. Cl. H01J 19/42

(52) U.S. Cl. 313/317

(57) ABSTRACT

The present invention relates to a decorative bulb of a series connected light string. The bulb is provided with at least one outer conductive fuse connected with two conductive wires to obtain a promised conductive purpose when the bulb is burned out. The light string can still work by use of the outer conductive fuse decorative bulb of a series connected light string.

### BACKGROUND OF THE INVENTION

The present invention refers to an improved decorative bulb, which includes an outer conductive fuse for providing a conductive purpose when the bulb is burned out.

Normally, a light string includes several bulb assemblies being connected in series. As one of the bulbs is broken, the light string will be out of use. And the broken bulb is not easy to be found out. In order to prevent the said drawback, an improvement, U.S. Ser. No. 09/769,478, is provided as shown in FIG. 1. It provides a fuse (12) between two conductive wires (11) and parallel to filament (13) in the bulb (1). When the filament (13) is burned out, the fuse (12) still connects the two conductive wires (11) and the light string remains lighting. In this prior design, as the fuse (12) is provided in the bulb (1), it must be coated with a protecting membrane. In actually manufacturing of sealing the bulb (1), the temperature is near to 600˜700° C. The protecting membrane on the fuse (12) will be damaged possibly so the conductive purpose is not good enough.

In order to solve this particular problem, the present invention mainly provides an improved decorative bulb, which includes an outer conductive fuse being connected easily and effectively for overcoming the drawback of prior art.

### BRIEF DESCRIPTION OF THE DRAWINGS

The following drawings indicate the structure of the related decorative bulb, along with background and features of the present invention.

FIG. 1 shows a perspective view of a conventional decorative bulb.

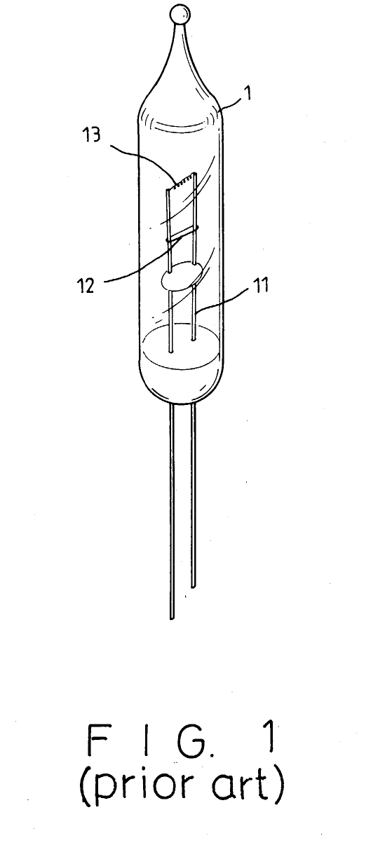

FIG. 2 shows a perspective view of a decorative bulb according the present invention.

FIG. 3 shows a perspective view of a modified decorative bulb according the present invention.

### DETAILED DESCRIPTION OF THE INVENTION

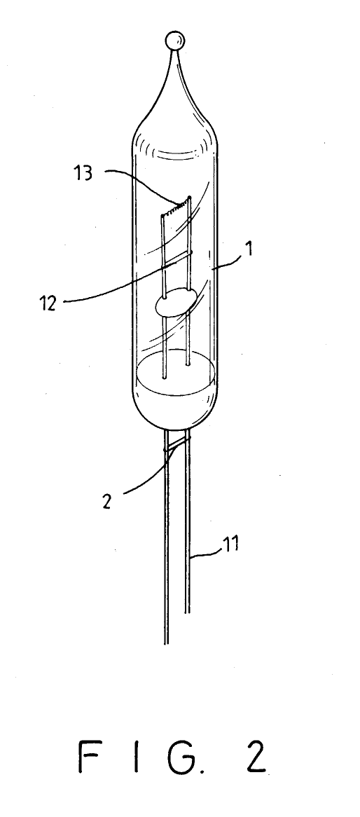

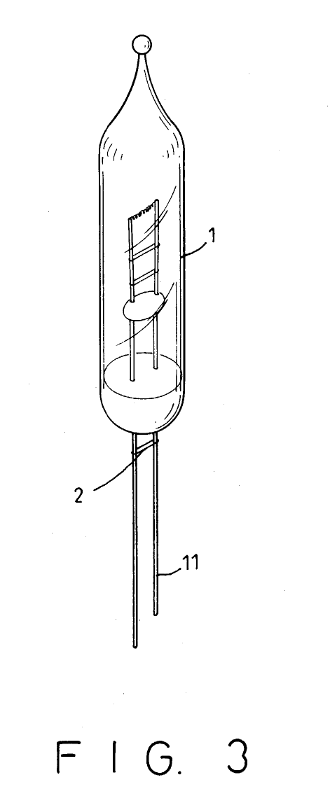

Referring to FIG. 2 or 3, the present invention includes a conventional bulb (1). The characteristic of the invention is to provide at least one outer conductive fuse (2) between two conductive wires (11) at a position under ball bottom of the bulb (1). The outer conductive fuse (2) is parallel to the filament (11) and the inner fuse (12).

As the filament (11) is burned out and the inner fuse (12) is out of use, the outer conductive fuse (2) can provide a perfect conductive effect for two conductive wires (11) as well as the light string. Only the broken bulb is not lighting and it can be found and replaced easily.

Since the outer conductive fuse (2) is provided outside the bulb, it will be very convenient to be connected at room temperature. Other than the commercial use, it is a novel, practical and progressive structure design that absolutely well worth your attention and the patent grant.

What is claimed is:

1. A decorative bulb of a series connected light string including a bulb with two conductive wires connecting with a filament and an inner fuse, and the characteristic is that an outer conductive fuse is connected with the two conductive wires at an outside position under ball bottom of the bulb.

2. The decorative bulb of a series connected light string as claimed in claim 1, wherein the conductive wires are connected with more than one outer conductive fuse.
